(19) United States
(12) Patent Application Publication
(10) Pub. No.: US 2015/0042472 A1
(43) Pub. Date: Feb. 12, 2015

(54) NON-BATTERY POWERED WIRELESS SECURITY SYSTEM

(71) Applicant: ZF Friedrichshafen AG, Friedrichshafen (DE)

(72) Inventors: Ronald Muetzel, Hawthorn Woods, IL (US); Thomas Roesch, Friedrichshafen (DE)

(73) Assignee: ZF Friedrichshafen AG, Friedrichshafen (DE)

(21) Appl. No.: 13/961,492

(22) Filed: Aug. 7, 2013

(51) Int. Cl. G08B 13/22

(52) U.S. Cl. CPC G08B 13/22
USPC 340/539.17

(57) ABSTRACT

A non-battery powered wireless security system may include one or more sensors. Each sensor may include a switch and a generator that creates electrical energy upon activation or motion of the switch in response to a change in condition of the location of the sensor. The system may utilize the electrical energy to transmit a security event signal to a receiver based on characteristics associated with the sensor, such as movement of the switch, location of the sensor, and time of sending the signal.

### BACKGROUND

Security systems may monitor and control environmental conditions and/or physical access by persons to a location or object. Such security systems may be implemented in many applications including but not limited to homes, commercial sites, temporary structures, outbuildings, vehicles, and safes. Security systems may include sensors or monitors positioned in and around a secured location at various remote positions including but not limited to potentially vulnerable positions of ingress and egress such as windows and doors. These remotely positioned sensors may sense a status or a change in status and trigger an appropriate response. For example, a sensor located at a window may sense that it has been opened and trigger an audible alarm and/or alert emergency personnel.

Remote sensors may require electric power to function and/or a conduit to transmit the sensed status. Electric power may be delivered to the sensors from a central source via conductive wiring. Likewise, a signal indicating a sensed status may be transmitted via wiring. Such wiring however may be expensive or impractical to install. Such wiring may also introduce vulnerabilities to security because, if such wiring is interrupted, the wired sensor may not function. If a wireless transmission method is utilized, a remote source of power, such as a battery may be required. However, a battery power source may require substantial physical space relative to that needed for the remote sensor, thereby affecting the placement of the remote sensor if the battery and the sensor are located together. If the battery is located apart from the sensor, the required wiring between the battery and the sensor has the disadvantages discussed above. Additionally, batteries only provide power if they have sufficient charge and may require monitoring for battery life and/or recurrent replacement.

Therefore, there is a need for a security system with one or more sensors that can operate independently of wired transmission and wired or battery power.

### SUMMARY OF THE INVENTION

The descriptions below include non-battery powered wireless security systems and methods of utilizing such systems. A non-battery powered wireless security system may include one or more sensors. Each sensor may include a switch and a generator that creates electrical energy upon activation or motion of the switch in response to a change in condition of the location of the sensor. The system may utilize the electrical energy to transmit a security event signal to a receiver based on characteristics associated with the sensor, such as movement of the switch, location of the sensor, and time of sending the signal.

According to one aspect, a security system may comprise at least one sensor and a remote receiver. The sensor may comprise a switch, a generator, and a transmitter. The switch may be operable to move relative to the rest of the sensor upon a change in condition of the location of the sensor. The generator may be operable to generate electrical energy, without the use of a battery, to power the transmitter upon movement of the switch. The transmitter may be operable to send wirelessly a signal indicating the condition of the location of the sensor upon movement of the switch. The remote receiver may be operable to receive the signal from the transmitter and interpret the signal based on at least one characteristic associated with the sensor.

According to another aspect, a security system may comprise a keypad and a remote receiver. The keypad may comprise one or more button assemblies and a transmitter. Each of the one or more button assemblies may comprise a switch and a generator. The switch may be operable to move relative to the rest of the keypad in response to a user input. The generator may be operable to generate electrical energy, without the use of a battery, to power the transmitter upon movement of the switch. The transmitter may be operable to send wirelessly a signal upon movement of the switch. The remote receiver may be operable to receive the signal from the transmitter and interpret the signal based on at least one characteristic associated with the button assembly.

According to another aspect, a method of securing a location with a security system may comprise generating electrical energy upon movement of a switch, the switch associated with a sensor at a location and configured to move upon a change in condition at the location; powering a transmitter with the electrical energy generated by the switch; and sending a signal wirelessly from a transmitter associated with the sensor, the signal based on at least one characteristic associated with the switch.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The embodiments described below may be more fully understood by reading the following description in conjunction with the drawings, in which

FIG. 1A is a cross section of an example of a radio-controlled switch according to an exemplary security system;

FIG. 1B is a schematic diagram of an example of a radio-controlled switch according to an exemplary security system;

FIG. 2 is a schematic diagram of an exemplary security system;

FIG. 3 is a schematic diagram of another exemplary security system;

FIG. 4 is a schematic diagram of an exemplary button assembly according to an exemplary security system;

FIG. 5 is a schematic diagram of another exemplary security system; and

FIG. 6 is a flow diagram of an exemplary method of securing a location using an exemplary security system.

### DETAILED DESCRIPTION

The exemplary systems and methods described herein may take a number of different forms. Not all of the depicted components may be required and some implementations may include additional, different, or fewer components from those expressly described in this disclosure. Variations in the arrangement and type of the components may be made without departing from the spirit or scope of the claims as set forth herein.

A non-battery powered wireless security system comprises one or more sensors that produce electrical energy when activated or when moved. The system utilizes the electrical energy to transmit a signal to a remote receiver. By producing its own electrical energy, the system may advantageously always be available to transmit a signal to a remote receiver. The signal may be an indication of a sensed status relevant to the security of a location or object.

A radio-controlled switch, for example, a snap-action switch, may comprise an antenna, a transmitter assembly, and a generator. The antenna may be electrically connected to the transmitter assembly to emit a signal that can be generated by the transmitter assembly. The transmitter assembly may be located on a circuit carrier and the antenna may be held on a carrier substrate within the radio-controlled switch that is separate from the circuit carrier. An example radio-controlled switch may be found in commonly-assigned U.S. patent application Ser. No. 13/636,306, the contents of which are incorporated herein by reference in their entirety. An example generator may be found in commonly-assigned U.S. patent application Ser. Nos. 13/636,307 and 13/636,309, the contents of which are incorporated herein by reference in their entirety.

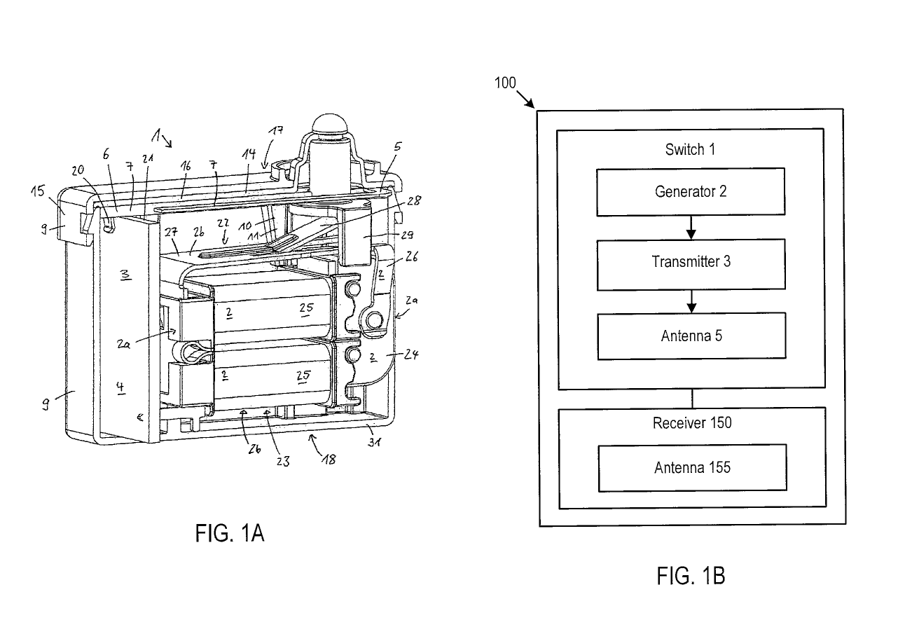

FIG. 1A shows the cross section of examplary switch 1, which is particularly implemented as an energy-independent radio-controlled switch 1. Such an energy-independent switch draws its energy from the actuation process or movement of switch 1, in which generator 2 of switch 1 is placed into operation. Generator 2, may be, for example, an induction generator or a piezo generator. Generator 2 provides energy to transmitter assembly 3. The energy may be buffered or stored, for example, in a capacitor or inductor.

Switch 1 may be, for example, a snap-action switch, in which a magnetic element is mechanically accelerated by a spring load during a movement of the magnetic element to reverse the polarity of the core of an induction coil of the generator. In general, switch 1 can be implemented as a monostable (one resting position), bistable (two resting positions), or metastable (stable against small changes, unstable against larger changes) radio-controlled switch 1.

Transmitter assembly 3 may generate a signal using the generated energy that is communicated to antenna 5 for emission as a radio signal or any other type of wireless signal. Transmitter assembly 3 may have circuit carrier 4, for example in the form of a circuit board, which supports the electronics of the transmitter assembly 3. Antenna 5 may be held on carrier substrate 6, for example, an antenna carrier, which is separate from circuit carrier 4. Circuit carrier 4 and carrier substrate 6 may each be separate substrates, or may be the same substrate.

Generator 2 in switch 1 may be be small and still provide high energy upon actuation or movement of switch 1. Generator 2 may be a miniaturized generator in the form of, for example, an induction snap generator in which magnetic element 24 is moved relative to induction coil 25. In addition, further compact generators 2 are possible that, for example, make use of other mechanisms for energy generation, e.g., piezo generators. In snap generator 2, a high acceleration of the magnetic element 24 between two resting points may cause a high temporal change in the magnetic flux, whereby the polarity of the core is reversed from the polarity of a switch in the rest position. The change in magnetic flux may cause generator 2 to create electrical energy.

To generate electrical energy, magnet element 24 may have a permanent magnet, and at least one induction coil with a coil core. Magnet element 24 may be arranged adjacent to the induction coil. Magnet element 24 may be movable relative to the coil core to generate a flux change in the core and generate energy in the form of, for example, an induction voltage or voltage by means of the induction coil. The energy may be emitted or conducted to another assembly of switch 1, for example, transmitter assembly 3.

The acceleration to move magnetic element 24 between two resting points may be caused by, for example, a snap movement. To generate a snap movement, spring element 26 connected to magnetic element 24 may be increasingly stressed during its movement between the resting positions until magnetic element 24 has reached a middle point between the resting positions. Upon reaching the middle point, energy stored by the stress on spring element 26 can be used for the mechanical acceleration of magnetic element 24 towards the resting position to be assumed by means of release of the spring element 26, resulting in an extremely accelerated approach of magnetic element 24 towards the core. Between the resting positions, magnetic element 24 may be moved away from contact with the flanks and moved along a suitable path, e.g. a circular arc shaped path, which permits an increasing and decreasing spring stress.

Additionally or alternatively, the acceleration to move magnetic element 24, which consequentially causes the generator to generate electrical energy, may be caused by movement of switch 1. Movement of switch 1 from a stationary position to a non-stationary position may cause magnetic element 24 to move between the resting positions, which may cause generator 2 to generate electrical energy. Similarly, continued movement of switch 1 may cause magnetic element 24 to move, which may cause generator 2 to generate electrical energy.

FIG. 1B is a schematic diagram of an example of a radio-controlled switch according to an exemplary sensor 100. Sensor 100 may also include additional components not shown in FIG. 1B. Sensor 100 may include switch 1, receiver 150, and antenna 155. The components of sensor 100 shown in FIG. 1B may correspond in function to similarly numbered components shown in FIG. 1A. Switch 1 (which may include generator 2, transmitter 3, antenna 5), receiver 150, and antenna 155 may be housed within a single device, as shown in FIG. 1B, or may be housed in separate devices that are in communication with each other. Transmitter 3 and receiver 150 may be may be combined into a transceiver. Further, one of antenna 5 or antenna 155 may be unnecessary where transmitter 3 and receiver 150 may share one antenna, or where a transceiver is employed in place of transmitter 3 and receiver 150.

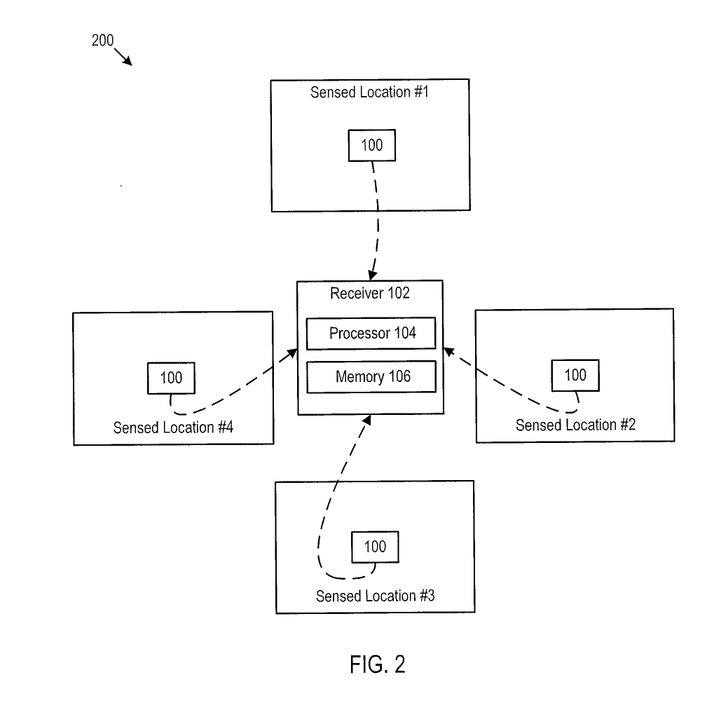

FIG. 2 is a schematic diagram of an exemplary security system 200. Security system 200 may include one or more sensors 100 that house switch 1 shown and described in relation to FIG. 1B. The size and shape of sensors 100 shown in FIG. 2 is for illustrative purposes only. Sensors 100 may take any size or shape dictated by design requirements. Security system 200 may include a receiver 102. Receiver 102 may include processor 104 and memory 106. Receiver 102 may be in communication with device 100 through a communication network. Additionally or alternatively, receiver 102 may be a transceiver that includes capabilities to send signals to device 100. Sensors 100 may communicate with receiver 102 according to any number of communication protocols, standards, networks, or topologies. As examples, sensor 100 may communicate across cellular networks or standards (e.g., 2G, 3G, Universal Mobile Telecommunications System (UMTS), GSM (R) Association, Long Term Evolution (LTE)™, or more), WiMAX, Bluetooth, WiFi (including 802.11 a/b/g/n/ac or others), WiGig, Global Positioning System (GPS) networks, and others available at the time of the filing of this application or that may be developed in the future. Sensor 100 and receiver 102 may include processing circuitry, data ports, transmitters, receivers, transceivers, or any combination thereof to communicate across any of the above-listed protocols, standards, networks, or topologies. Receiver 102 may be remotely located from sensor 100 as shown in FIG. 2, or may be attached or in close proximity to sensor 100. Sensors 100 may be distributed in different locations throughout a secured location. The sensed locations may be positions of potential vulnerability in security, including but not limited to points of entry or exit, such as windows, doors, overhead doors, pet doors, and skylights. In FIG. 2, sensors 100 are located in Sensed Locations #1-4 by example only. Any number of sensors 100 may be located in any number of locations. Multiple sensors may be located in the same location or proximate locations for redundancy.

Security system 200 may generate electrical energy and transmit a signal when activated by a change in condition at a sensed location, such as through push-button activation, or motion of the sensor 100. As previously described, generator 2 in switch 1 contained in sensor 100 may create electrical energy when a magnet element is moved between two resting points.

Generator 2 may create electrical energy when sensor 100 is activated by the movement of an object adjacent to sensor 100 or when sensor 100 is moved. For example, sensor 100 may be located in a window jamb, wherein a closed window biases the switch 1 in a position. Upon opening the window, switch 1 may no longer be biased by the window and may be caused to move to another position by, for example, the biasing force of a spring held in compression by the closed window. For another example, sensor 100 could be placed in or on the floor near a door or passageway. The pressure of an object, such as the foot of a person walking through the area, may move switch 1 downward, activating it. For another example, sensor 100 may be located on or in a door wherein the motion of the opening or closing of the door, and the accompanied motion of sensor 100, activates switch 1. These are only examples of many different methods of activation of switch 1 by motion of an object adjacent to sensor 100 or by motion of sensor 100 itself indicating a change in condition of the sensed location.

Sensor 100 may include a mechanism to store energy that is created when switch 1 is moved. The stored energy may be used by sensor 100 to transmit a signal when sensor 100 is not generating electricity, such as when sensor 100 is stationary. The mechanism to store energy may include, for example, a rechargeable storage battery, capacitor, or ultra-capacitor if the stored energy is electrical, or the mechanism to store energy may include a spring if the stored energy is mechanical. Stored mechanical energy may be converted to electrical energy by generator 2. By creating its own electrical energy, security system 200 may be energy independent and may not require a separate power source, such as a battery or a building's electrical circuitry or power. As such, security system 200 may always be operable to transmit a signal indicating a security event because it does not rely on a separate power source. Such security event may include but is not limited to a presence of an authorized or unauthorized person in a secure location, an open status of an entrance or exit, a closed status of an entrance or exit, or damage or breaking of a window.

Sensor 100 may use the electrical energy created by generator 2 to transmit a signal from transmitter 3 and antenna 5. Sensor 100 may be configured to transmit a signal when sensor 100 is moved. The movement to cause sensor 100 to transmit a signal may be the same type of movement that was previously described in relation to sensor 100 creating electrical energy. Additionally or alternatively, sensor 100 may be configured to transmit a signal at predefined time intervals, such as every minute or every hour. The time intervals may be modified by a user or other party with access to security system 200. Additionally or alternatively, sensor 100 may be configured to transmit a signal based on a combination of movement and time intervals. Using such a combination may allow sensor 100 to efficiently use the electrical energy created by generator 2. For example, sensor 100 may be configured to transmit a signal when moved and to also transmit a signal at specified time intervals when sensor 100 is stationary. Any other combinations of movement, non-movement, and time intervals may be used by sensor 100 to transmit a signal. Sensor 100 may be configured to transmit a signal and work independently from user instruction.

The signals transmitted by sensor 100 may be received by receiver 102. The signals may be transmitted wirelessly through a communication network, as previously described, or may be sent wirelessly directly from sensor 100 to receiver 102. Direct communication with a relatively proximate receiver 102, for example, a receiver 102 in the same secured location as sensor 100, may reduce the signal strength required for a signal transmitted from sensor 100 to reach a receiver 102. Reducing the required signal strength may allow sensor 100 to transmit signals more often, more efficiently, or with more information included in the signal. Including a relatively proximate receiver 102 may also eliminate the need for a communication network to transmit the signal from sensor 100 to a receiver 102, which may increase the reliability of security system 200.

Receiver 102 may receive the signals and may interpret the signals based on characteristics associated with sensor 100. Processor 104 in receiver 102 may interpret the signals based on logic or instructions stored in memory 106. Characteristics associated with sensor 100 may include, for example, the presence or absence of movement of sensor 100. The movement of sensor 100 may be the same movement as previously described in relation to sensor 100 creating electrical energy. Additionally, the signal may indicate the identity of sending sensor 100 among multiple sensors by characteristics including but not limited to signal strength, source location, frequency, amplitude, or other information carried by the signal. Receiver 102, through processor 104 and memory 106, may interpret movement or the absence of movement of sensor 100 as an indication of a security event. Additionally or alternatively, receiver 102 may interpret the signals from sensor 100 and may cause a security action in response, such as causing an audible alarm to be sounded, or to transmit another signal indicating an emergency alert or other signal requiring immediate attention. Receiver 102 may be in communication with other parties including but not limited to, users, police, hospitals, ambulances, fire departments, security services, or other emergency response personnel.

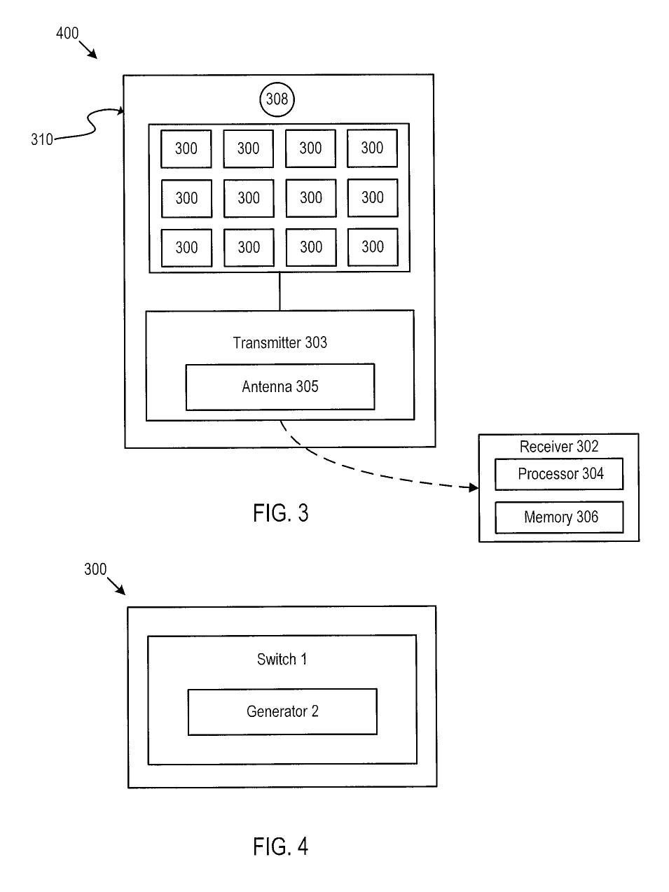

FIGS. 3, 4, and 5 illustrate another exemplary security system. As shown in FIG. 3, security system 400 may include a keypad 310. Keypad 310 may include one or more button assemblies 300. As shown in FIG. 4, each button assembly 300 may include switch 1 which in turn may have generator 2. Switch 1 and generator 2 have similar functions and capabilities as the like-numbered components described above in connection with FIGS. 1 and 2. Keypad 310 may send signals to receiver 302 through transmitter 303 and antenna 305 upon movement of a switch 1 in one of the button assemblies 300. Transmitter 303, antenna 305, and receiver 302 have similar functions and capabilities as the like-numbered components described above in connection with FIGS. 1 and 2, except that each button assembly 300 may not have a unique transmitter 303 and antenna 305. Keypad 310 may have multiple button assemblies, each with switch 1 and generator 2, which may all be connected to transmitter 303. Keypad 310 may also have a status indicator 308, which may include but is not limited to one or more LEDs or and LCD display. Status indicator 308 may indicate to a user the status of security system 400 and additionally or alternatively may indicate the activation of a button assembly 300.

Generator 2 in button assembly 300 may create electrical energy when sensor button assembly is activated by user input. For example, a user may press a button associated with button assembly 300, causing switch 1 to move. This electrical energy may power transmitter 303 to send a signal to receiver 302. This electrical energy may also power status indicator 308.

Receiver 102 may receive the signals and may interpret the signals based on characteristics associated with button assembly 300. Processor 304 in receiver 302 may interpret the signals based on logic or instructions stored in memory 306. The signal may indicate the identity of the sending button assembly 300 among multiple button assemblies by characteristics including but not limited to signal strength, source location, frequency, amplitude, or other information carried by the signal.

Keypad 310 may be utilized by a user to configure security system 400 and/or to cause a security action. A user may activate one or more button assemblies to enter a code sequence to achieve a desired security action from security system 400. Button assemblies may be associated with a specific security event or security action, or may be associated with one or more code segments including but not limited to alphanumeric characters. Activation of one or more button assemblies may cause one or more associated signals to be sent to receiver 302. Receiver 302 may interpret a series of signals associated with button assemblies as a code sequence. If the received code sequence matches a preconfigured code sequence, the receiver may cause a security action including but not limited to setting security system 400 to an armed state, setting security system 400 to a disarmed state, sounding an audible alarm, and/or transmitting another signal indicating an emergency alert or other signal requiring immediate attention to a remote party, such as emergency response personnel. If the received code sequence does not match a preconfigured code sequence, the receiver may also cause a security action, which may be different than the security action caused by a matching code sequence.

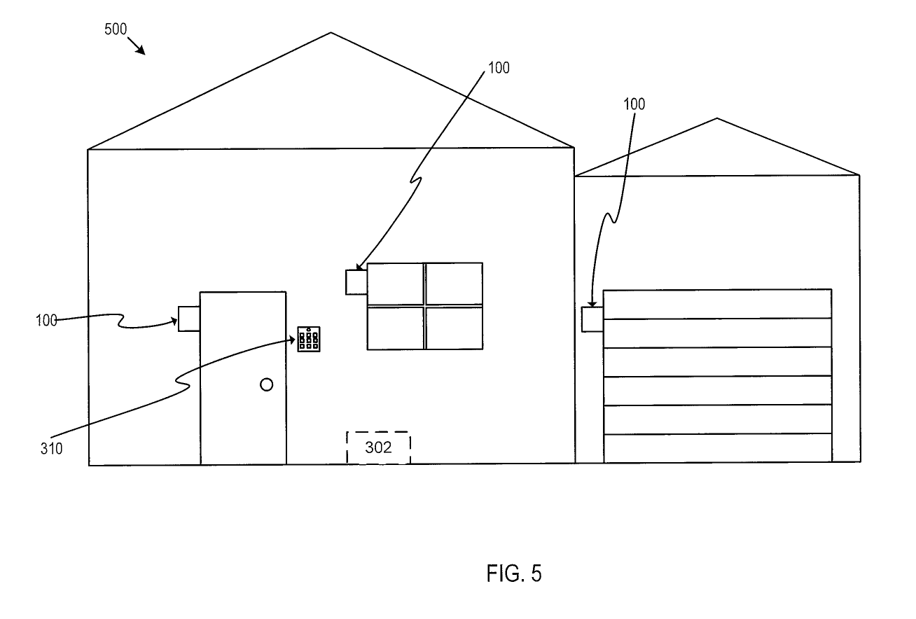

FIG. 5 illustrates security system 500 incorporating one or more keypads 310 and one or more sensors 100 located in various sensed location around a secured location, for example, a residential home. Keypad 310 and sensors 100 send signals upon activation to one or more receivers 302. Whereas keypad 310 and sensors 100 may be located at potentially vulnerable positions, for example, at a door, window, and/or overhead garage access, receiver 302 may be centrally located in a secured location, for example, in the middle of the residential home. Because keypad 310 and sensors 100 are energy independent and wireless, they are less vulnerable to manipulation by unauthorized personnel. For example, because keypad 310 and sensors 100 are not wired to a building electrical supply, the security system cannot be compromised by power interruption through power outage or the cutting of wires. Alternatively, sensors 100 may be connected to the building electrical supply as a primary source of power and may rely on the energy-generating capabilities of generator 2 when the primary source fails. Because receiver 302 is in a secured location, it may be connected to the building electrical supply and/or have a battery backup.

Any of the security systems 200, 400, or 500 or their components may be able to communicate with other systems or devices. Keypads 310 and sensors 100 may be able to transmit signals to issue commands or instructions to other devices. For example, commands may be sent to turn on lights in a room when the security systems determine that a sensor or keypad button assembly indicates that an authorized user is entering the room. Commands may be sent to communication devices, such as a user's cellular phone, laptop, or other personal computing device, such that the device will alert designated individuals regarding the status of the security system. For example, the security systems may command a user's telephone to send a text message to another user's telephone, for example the user's spouse's telephone, if a security event occurs at the home of one of the users.

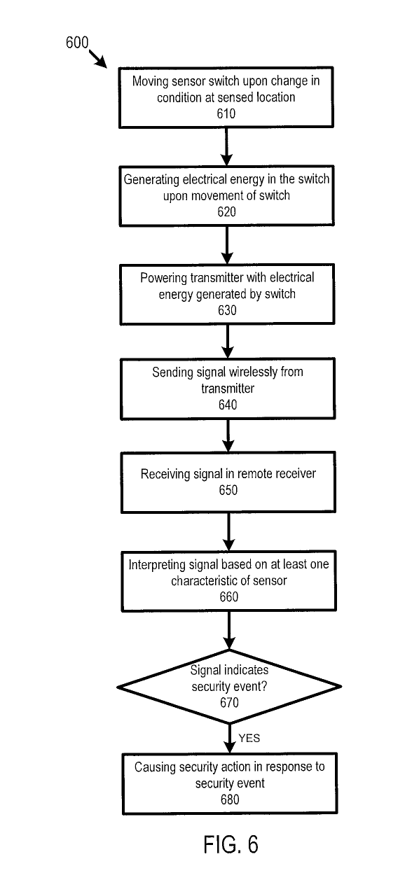

FIG. 6 is a flow diagram of a method for securing a location using an exemplary security system. The method 600 may be implemented as hardware, software, or both, for example in sensor 100, keypad 310, button assembly 300, receiver 102, a computer connected to receiver, either directly or remotely through a communication network, or any combination. Method 600 may start at step 610 by capturing movement of a sensor upon a change in condition at a sensed location or upon input from a user, where the sensor includes a switch, a generator, and a transmitter. At step 620, the generator may generate electrical energy as a result of the sensor moving in step 510. At step 630, the electrical energy generated in step 620 may power a transmitter in the sensor. At step 640, the transmitter may send a wireless signal. The signal may be received by a receiver in step 650. After receiving the signal, in step 660 the receiver may interpret the signal based on a characteristic associated with the sensor. At step 670, the receiver may determine whether the signal or signals received indicate a security event. At step 680, if the receiver does determine that the signal or signals indicate a security event at step 670, then the receiver may cause a security action in response to the security event.

Methods or processes may be implemented, for example, using a processor and/or instructions or programs stored in a memory. Specific components of the disclosed embodiments may include additional or different components. A processor may be implemented as a microprocessor, microcontroller, application specific integrated circuit (ASIC), discrete logic, or a combination of other types of circuits or logic. Similarly, memories may be DRAM, SRAM, Flash, or any other type of memory. Parameters, databases, and other data structures may be separately stored and managed, may be incorporated into a single memory or database, or may be logically and physically organized in many different ways. Programs or instruction sets may be parts of a single program, separate programs, or distributed across several memories and processors.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A security system comprising:
at least one sensor located at a location, the at least one sensor comprising a switch with a generator, and a transmitter; and
a remote receiver;
wherein the switch is operable to move relative to the rest of the sensor upon a change in condition of the location;
wherein the generator is operable to generate electrical energy without the use of a battery to power the transmitter upon movement of the switch;
wherein the transmitter is operable to send wirelessly a signal indicating the condition of the location upon movement of the switch; and
wherein the remote receiver is operable to receive the signal from the transmitter and interpret the signal based on at least one characteristic associated with the sensor.

2. The security system of claim 1, wherein the location is a point of entry or exit of a secured location.

3. The security system of claim 2, wherein the condition of the location comprises the status of the point of entry or exit and wherein the remote receiver interprets the signal as a security event when the status is closed or open.

4. The security system of claim 1, wherein the at least one characteristic associated with the switch comprises the movement of the switch.

5. The security system of claim 1, wherein the at least one characteristic associated with the sensor comprises the location of the sensor.

6. The security system of claim 1, wherein the at least one characteristic associated with the sensor is the time at which the signal is sent.

7. The security system of claim 1, wherein the remote receiver utilizes configurable thresholds of the at least one characteristic associated with the switch to interpret the signal.

8. The security system of claim 7, wherein the configurable thresholds comprise a switch movement threshold and wherein the remote receiver interprets the signal as a security event upon movement of the switch exceeding the switch movement threshold.

9. A security system comprising:
a keypad comprising one or more button assemblies and a transmitter; and
a remote receiver;
wherein each of the one or more button assemblies comprise a switch with a generator;
wherein the switch is operable to move relative to the rest of the keypad in response to a user input;
wherein the generator is operable to generate electrical energy without the use of a battery to power the transmitter upon movement of the switch;
wherein the transmitter is operable to send wirelessly a signal upon movement of the switch; and
wherein the remote receiver is operable to receive the signal from the transmitter and interpret the signal based on at least one characteristic associated with the button assembly.

10. The security system of claim 9, wherein the at least one characteristic associated with the button assembly comprises a distinct code segment.

11. The security system of claim 10, wherein the distinct code segment is an alphanumeric character.

12. The security system of claim 9, wherein the remote receiver is operable to interpret a series of one or more signals associated with one or more button assemblies as a code sequence, wherein the remote receiver causes a security action upon reception of a code sequence of signals matching or not matching a preconfigured code sequence.

13. The security system of claim 9, further comprising
at least one sensor located at a location, the at least one sensor comprising a sensor switch, a sensor generator, and a sensor transmitter; and
wherein the sensor switch is operable to move relative to the rest of the sensor upon a change in condition of the location;
wherein the sensor generator is operable to generate electrical energy, without the use of a battery, to power the sensor transmitter upon movement of the sensor switch;
wherein the sensor transmitter is operable to send wirelessly a sensor signal indicating the condition of the location upon movement of the sensor switch; and
wherein the remote receiver is operable to receive the signal from the transmitter and interpret the sensor signal based on at least one characteristic associated with the sensor.

14. A method of securing a location with a security system, the method comprising:
generating electrical energy upon movement of a switch, the switch associated with a sensor at a location and configured to move upon a change in condition at the location;
powering a transmitter with the electrical energy generated by the switch; and
sending a signal wirelessly from a transmitter associated with the sensor, the signal based on at least one characteristic associated with the switch.

15. The method of claim 14, further comprising:
receiving the signal in a remote receiver; and
interpreting the signal in the remote receiver to identify at least one characteristic associated with the switch.

16. The method of claim 15, further comprising:
determining that the signal indicates a security event; and
causing a security action in response to the security event.

17. The method of claim 15, wherein the characteristic associated with the switch comprises movement of the switch and wherein the receiver interprets the signal as a security event.

18. The method of claim 15, wherein the characteristic is identifiable based on the amplitude, frequency, phase, or a combination of amplitude, frequency or phase.

19. The method of claim 15, wherein the characteristic is indicative of a location, time, date, or condition.

20. The method of claim 15, wherein the characteristic is indicative of a security breach.
